(19) United States
(12) Patent Application Publication
(10) Pub. No.: US 2010/0209774 A1
(43) Pub. Date: Aug. 19, 2010

(54) Non-aqueous electrolyte secondary battery and method of manufacturing the same

(75) Inventors: Hiroshi Minami, Kobe-shi (JP); Naoki Imachi, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO Electric Co., Ltd., Osaka (JP)

(21) Appl. No.: 12/656,763

(22) Filed: Feb. 16, 2010

(30) Foreign Application Priority Data
Feb. 16, 2009 (JP) 2009-032139

(51) Int. Cl. H01M 4/58; H01M 10/04

(52) U.S. Cl. 429/218.1; 29/623.5

(57) ABSTRACT

An inorganic particle layer, provided on a surface of a positive electrode, containing inorganic particles, a dispersion stabilizer made of at least one of a polyacrylic acid and a polyacrylate, and a water-system binder that is different from the dispersion stabilizer. A non-aqueous electrolyte secondary battery that has the inorganic particle layer, a positive electrode containing a positive electrode active material, a negative electrode containing a negative electrode active material, a non-aqueous electrolyte, and a separator provided between the positive electrode and the negative electrode.

### BACKGROUND OF THE INVENTION

1. Field of the Invention

The present invention relates to non-aqueous electrolyte secondary batteries, such as lithium-ion secondary batteries, and methods of manufacturing the batteries.

2. Description of Related Art

Rapid advancements in size and weight reductions of mobile information terminal devices such as mobile telephones, notebook computers, and PDAs in recent years have created demands for higher capacity batteries as driving power sources for such devices. Moreover, the mobile information terminal devices tend to consume more and more power, as the functions of the devices, such as video playing functions and gaming functions, become more complex and diverse. Consequently, it is strongly desired that lithium-ion batteries that are the driving power sources for the devices have further higher capacities and higher performance in order to achieve longer battery life and improved output power.

The theoretical capacity of lithium cobalt oxide, which is commonly used as the positive electrode active material of the lithium-ion batteries, is about 273 mAh/g. However, when the end-of-charge potential of the positive electrode is set at 4.30 V (vs. Li/Li⁺), the batteries utilizes only up to about 160 mAh/g of the capacity. When the end-of-charge potential is raised to 4.50 V (vs. Li/Li⁺), it becomes possible to use up to about 200 mAh/g of the capacity. As a result, about 10% increase in the overall battery capacity can be accomplished. It should be noted that, when a carbon material is used as the negative electrode active material, the end-of-charge potential of the negative electrode is about 0.1 V (vs. Li/Li⁺). Therefore, when the end-of-charge potential of the positive electrode is 4.30 (vs. Li/Li⁺), the end-of-charge potential of the battery is 4.20 V.

Nevertheless, if the end-of-charge potential is set to higher than 4.30 V (vs. Li/Li⁺), the oxidation power of the charged positive electrode active material will become higher. Consequently, the decomposition of the electrolyte solution is accelerated. Moreover, the crystal structure of the delithiated positive electrode active material itself becomes instable, causing crystal disintegration. Therefore, battery performance deterioration, such as cycle life deterioration and storage performance deterioration, becomes a problem even at a temperature in the vicinity of 50° C., at which the problem did not arise with a lower end-of-charge potential.

In a battery system that uses a positive electrode active material such as lithium cobalt oxide, lithium manganese oxide, and lithium nickel-cobalt-manganese composite oxide, the elements (for example, Co and Mn) contained in the positive electrode active material dissolve in the electrolyte as ions during storage at high-temperatures, so deposition of Co and Mn is observed on the negative electrode and the separator. The deposition of Co and Mn on the negative electrode and the separator causes problems such as an increase in the internal resistance and an accompanying capacity loss.

When a spinel-type lithium manganese oxide is used as the positive electrode active material, Mn and the like dissolve from the positive electrode active material and the problems such as storage performance deterioration arise, even if the end-of-charge potential of the positive electrode is set at 4.30 V (vs. Li/Li⁺).

To prevent the problems such as storage performance deterioration, it is conceivable to provide an inorganic particle layer on the positive electrode surface. It is believed that the inorganic particle layer inhibits the ions of the elements that have dissolved from the positive electrode active material in the electrolyte from reaching the negative electrode, preventing the deposition of the elements such as Co and Mn.

Patent Document 1 describes that an inorganic particle layer containing inorganic particles and a binder is provided on at least one surface of the separator. Patent Documents 2 and 3 describe that stability against nail penetration or the like is improved by forming a porous insulating layer on a surface of the positive electrode or the negative electrode. Patent Document 4 describes that permeability of the electrolyte solution in the battery is improved by forming recessed and projecting parts on a porous layer. Patent Document 5 describes that the negative electrode contains a polyacrylic acid to improve adhesion. Patent Document 6 discloses a lithium cobalt oxide containing Zr and Mg.

Patent Document 7 describes a surface treatment method for inorganic particles. Specifically, it describes a method of producing a surface-treated titanium dioxide pigment. According to Patent Document 7, first, titanium oxide is reacted with sodium silicate aqueous solution (70° C., pH 4) to form a surface film of SiO₂ on the surface of the titanium oxide. Thereafter, the resultant material is reacted with aluminum hydroxide aqueous solution (pH 7.5) to form a surface film composed of Al₂O₃. Then, an organometallic compound is coated thereon, whereby a surface-treated titanium dioxide pigment can be produced. SiO₂ and Al₂O₃ adhere on the surface of the titanium dioxide treated in that way. Therefore, it is possible to confirm whether or not the surface-treatment layer is provided on the surface of the inorganic particles by measuring the amounts of Al and Si in a composition analysis of the inorganic particles.

### Citation List

[Patent Documents]

[Patent Document 1] Japanese Published Unexamined Patent Application No. 2007-280911

[Patent Document 2] Japanese Patent No. 3371301 [Patent Document 3] Published PCT application No. WO 2005/057691 A1

[Patent Document 4] Japanese Published Unexamined Patent Application No. 2005-259467

[Patent Document 5] Japanese Published Unexamined Patent Application No. 2007-115671

[Patent Document 6] Japanese Published Unexamined Patent Application No. 2005-50779

[Patent Document 7] Japanese Published Unexamined Patent Application No. H09 (1997)-25429.

### BRIEF SUMMARY OF THE INVENTION

When an organic solvent such as N-methyl-pyrrolidone (NMP) is used as a solvent of a slurry for forming the inorganic particle layer, a slurry with good dispersion stability can be obtained. However, a problem arises that, when coating the slurry on the positive electrode, the solvent and the binder diffuse in the electrode and the binder in the positive electrode swells, resulting in a decrease in energy density.

Accordingly, it is an object of the invention to prepare a good water-system slurry for forming an inorganic particle layer in a non-aqueous electrolyte secondary battery in which an inorganic particle layer is provided on the positive electrode surface and in a manufacturing method of the battery. It is also an object of the invention to improve high-temperature storage performance of a non-aqueous electrolyte secondary battery and to prevent deterioration of discharge rate performance of the battery.

The present invention provides a non-aqueous electrolyte battery comprising: a positive electrode containing a positive electrode active material, a negative electrode containing a negative electrode active material, a non-aqueous electrolyte, a separator provided between the positive electrode and the negative electrode, and an inorganic particle layer provided on a surface of the positive electrode, wherein the inorganic particle layer contains inorganic particles, a dispersion stabilizer comprising at least one of a polyacrylic acid and a polyacrylate, and a water-system binder that is different from the dispersion stabilizer.

Since the inorganic particle layer contains the dispersion stabilizer comprising a polyacrylic acid or a polyacrylate, a water-system slurry with good dispersion stability can be obtained. As a result, a good inorganic particle layer in which the inorganic particles are dispersed uniformly can be formed. Thus, the decomposition product of the non-aqueous electrolyte resulting from the reaction at the positive electrode as well as the elements dissolved away from the positive electrode active material can be trapped by the inorganic particle layer. As a result, the deposition of Co and/or Mn on the negative electrode surface and the separator can be prevented. This makes it possible to alleviate damages to the negative electrode and the separator, and to prevent the high-temperature storage performance from degrading, so that deterioration in the discharge rate performance can be prevented. It should be noted that the term “dispersion stabilizer” refers to an agent used to inhibit sedimentation of the inorganic particles contained in a water-system slurry so as to uniformly disperse the inorganic particles contained in the water-system slurry, and the phrase “dispersion stability is high” refers to a condition in which sedimentation of the inorganic particles is inhibited so that the inorganic particles are uniformly dispersed.

The polyacrylic acid and the polyacrylate do not electrochemically react easily in the battery, so the battery performance does not degrade even when the inorganic particle layer contains the polyacrylic acid or the polyacrylate.

In addition, the water-system slurry is preferable also from an environmental point of view because it uses water as the solvent.

In another embodiment of the invention, it is preferable that inorganic particles that do not have a surface-treatment layer be used as the inorganic particles.

Such inorganic particles contain little amount of impurities containing Fe. Therefore, micro-short circuiting between the positive electrode and the negative electrode can be prevented.

Even when the water-system slurry is prepared using the inorganic particles on which no surface-treatment layer is provided, it is possible to prevent aggregation of the inorganic particles and form an inorganic particle layer in which the inorganic particles are dispersed desirably because the polyacrylic acid or the polyacrylate is used as a dispersion stabilizer. Therefore, the inorganic particle layer exhibits its filtering function sufficiently, improving the high-temperature storage performance and preventing the discharge rate performance from degrading.

In another embodiment of the invention, it is preferable that the polyacrylic acid and/or the polyacrylate have a degree of polymerization of from 22000 to 66000.

By setting the degree of polymerization to 22000 or greater, sedimentation of the inorganic particles can be inhibited for more than several hours after the water-system slurry has been prepared, so that the dispersion capability of the inorganic particles can be ensured. In addition, by setting the degree of polymerization to 66000 or less, the water-system slurry can obtain a viscosity that is desirable for making the inorganic particle layer into a thin film. When the viscosity of the water-system slurry is high, in other words, when the degree of polymerization of the dispersion stabilizer is higher than 66000, the non-aqueous electrolyte does not permeate or diffuse easily in the inorganic particle layer, and therefore, the discharge rate performance degrades.

In another embodiment of the invention, it is preferable that the concentration of the dispersion stabilizer be within a range of from 0.01 parts by mass to 0.5 parts by mass, and more preferably from 0.05 parts by mass to 0.2 parts by mass, per 100 parts by mass of the inorganic particles.

Setting the concentration of the dispersion stabilizer to 0.01 parts by mass or greater per 100 parts by mass of the inorganic particles can inhibit sedimentation of the inorganic particles and ensure sufficient dispersion capability of the inorganic particles. As a result, it is possible to sufficiently obtain the advantageous effects such as ensuring uniform dispersion of the inorganic particles in the inorganic particle layer, improvement in the high-temperature storage performance, and prevention of the degradation in the discharge rate performance. In addition, setting the concentration of the dispersion stabilizer to 0.5 parts by mass or less enables the water-system slurry to obtain a viscosity that is desirable for making the inorganic particle layer into a thin film. Moreover, the dispersion stabilizer does not hinder lithium ion conduction in the battery, and the rate performance does not deteriorate.

In another embodiment of the present invention, it is preferable that the secondary battery according to the present invention be used when the positive electrode has a filling density of 3.40 g/cm³ or greater. It is more preferable that the positive electrode has a filling density of from 3.40 g/cm³ to 3.90 g/cm³. This is because the storage performance of the battery tends to be lower when the positive electrode has a higher filling density.

Specifically, it is believed that the deterioration of the storage performance of the battery is related to the surface area of the positive electrode active material layer that is in contact with the electrolyte and the degree of deterioration of the portion where side reactions occur. Specifically, when the filling density of the positive electrode is less than 3.40 g/cm³, the deterioration of the storage performance proceeds uniformly over the entire positive electrode, not locally, so it does not significantly affect the charge-discharge reactions after storage. On the other hand, in the prior art, when the filling density is 3.40 g/cm³ or greater, the deterioration takes place mainly in the outermost surface layer of the positive electrode, so the entry and diffusion of lithium ions in the positive electrode active material during discharge become the rate-determining processes. Consequently, the degree of the deterioration of the positive electrode is believed to be significant in the prior art.

The non-aqueous secondary battery according to the present invention contains a good inorganic particle layer in which the inorganic particles are dispersed uniformly. Therefore, even when the positive electrode has a filling density of 3.40 g/cm³ or greater, the deterioration of the storage performance is inhibited.

In another embodiment of the invention, it is preferable that the non-aqueous electrolyte secondary battery be charged until the end-of-charge potential of the positive electrode reaches higher than 4.30 V (vs. Li/Li⁺) to improve the electrical charge and discharge capacity of the non-aqueous electrode secondary battery. When the end-of-charge potential of the positive electrode is set to be high, the transition metals such as Co and Mn tend to dissolve from the positive electrode active material in the electrolyte more easily. However, by adopting the inorganic particle layer according to the present invention for the battery, the Co and Mn that have dissolved can be prevented from depositing on the negative electrode surface. As a result, the high-temperature storage performance can be prevented from degrading even when the battery is charged in such a manner that the end-of-charge potential of the positive electrode is higher than the conventional batteries.

The present invention also provides a method of manufacturing the above-described non-aqueous electrolyte secondary battery according to the invention, comprising the steps of: preparing a water-system slurry containing inorganic particles, a dispersion stabilizer comprising a polyacrylic acid or a polyacrylate, and a water-system binder; coating the water-system slurry onto a surface of the positive electrode to form an inorganic particle layer; and manufacturing a non-aqueous electrolyte secondary battery by using a positive electrode on which the inorganic particle layer is formed on the surface, a negative electrode, a non-aqueous electrolyte, and a separator.

In the manufacturing method of the present invention, sedimentation of the inorganic particles is inhibited because the water-system slurry is prepared containing the dispersion stabilizer comprising a polyacrylic acid or a polyacrylate, so a water-system slurry in which the inorganic particles are dispersed uniformly can be obtained. As a result, an inorganic particle layer in which the inorganic particles are dispersed in a desirable manner can be formed on the positive electrode surface. Thus, the high-temperature storage performance of the non-aqueous electrolyte secondary battery is improved, whereby the discharge rate performance can be prevented from degrading.

According to the present invention, a non-aqueous electrolyte secondary battery in which an inorganic particle layer is formed on the positive electrode surface and a manufacturing method of the battery are provided, and the inorganic particle layer can be formed in a desirable manner using a water-system slurry. In addition, a non-aqueous electrolyte secondary battery in which the discharge rate performance is prevented from degrading can be provided by manufacturing the non-aqueous electrolyte secondary battery using the inorganic particle layer according to the present invention.

Moreover, the non-aqueous electrolyte secondary battery according to the present invention is excellent in high-temperature storage performance. Therefore, the discharge rate performance of the non-aqueous electrolyte secondary battery is prevented from degrading even if the operating environment is higher than 50° C.

### DETAILED DESCRIPTION OF THE INVENTION

Hereinbelow, the present invention is described in further detail based on examples thereof. However, the present invention is not limited to the following examples. Various changes and modifications are possible without departing from the scope of the invention.

### 1. Evaluation of Impurities in Inorganic Particles

An aluminum oxide (Al₂O₃ made by Sumitomo Chemical Co., Ltd., trade name: AKP 3000, average particle size: 0.6 μm), a titanium oxide (TiO₂ made by Ishihara Sangyo Co., Ltd., trade name: CR-EL, average particle size: 0.25 μm), and another titanium oxide (TiO₂ made by Titan Kogyo Co., Ltd., trade name: KR380, average particle size; 0.38 μm) were chosen as usable inorganic particles. Table 1 shows the purity, the average particle size, and the presence or absence of a surface-treatment layer of each of the materials. In addition, Table 1 also shows the presence or absence of impurity particles having a particle size of greater than 100 μm (indicated as “presence of impurity particles”).

The method of the evaluation will be described. First, 500 g of inorganic particles and a magnet for collecting impurities are placed in a plastic container provided with a lid and agitated together with the container for 1 hour. Thereafter, the magnet was recovered and washed with water. Then, the size of the impurities that adhered to the magnet was determined using SEM, and the composition of the impurities was determined using EDX.

TABLE 1

| | | Average | Presence of | Presence of |
|---|---|---|---|---|
| | Purity | particle size | surface | impurity |
| Inorganic particle | (%) | (μm) | treatment layer | particles |
| TiO₂ (KR380) | 95.10 | 0.38 | Yes | Yes |
| TiO₂ (CR-EL) | 99.99 | 0.25 | No | No |
| Al₂O₃ (AKP3000) | 99.99 | 0.60 | No | No |

Impurity particles having a particle size of greater than 100 μM were observed in the titanium oxide (KR380) having a surface-treatment layer. No impurity particles having a particle size of greater than 100 μM were observed in the aluminum oxide (AKP3000) and titanium oxide (CR-EL) that had no surface-treatment layer.

The composition of the impurity particles that had adhered to the magnet was determined by EDX for the titanium oxide (KR380), and as a result, it was found that the impurity particles contained Fe (Fe alone or SUS). It should be noted that the purity of the inorganic particles becomes less than 99.9% by forming a surface-treatment layer on the inorganic particle surface.

For the inorganic particles (KR380) that were surface-treated, it is believed that the impurities containing Fe originate from the equipment for forming a surface film of SiO₂, Al₂O₃, or the like.

### 2. Preparation of Battery (1)

### Example 1

### Preparation of Positive Electrode

A lithium cobalt oxide was prepared as a positive electrode active material. In the lithium cobalt oxide, 1.0 mole % of Al and 1.0 mole % of Mg were contained in the form of solid solution, and 0.05 mole % of Zr was also contained in the form of a solid solution. Using the positive electrode active material, acetylene black as a carbon conductive agent, and PVDF (polyvinylidene fluoride) were mixed at a mass ratio of 95:2.5:2.5, then NMP was added thereto as a solvent, and the mixture was mixed with a mixer to obtain a slurry for the positive electrode. This was coated onto both sides of an aluminum foil, and then dried and calendered, to prepare a positive electrode. The filling density of the positive electrode was 3.60 g/cm³.

It is possible to use a positive electrode active material having a layered structure. In particular, a lithium-containing transition metal oxide having a layered structure is preferable. When the end-of-charge potential of the positive electrode is set at 4.30 V (vs. Li/Li⁺) or higher, it is preferable to use a positive electrode active material that can increase the capacity. Examples of the lithium transition metal oxide include lithium composite oxides containing cobalt or manganese, such as lithium cobalt oxide, lithium-cobalt-nickel-manganese composite oxide, lithium-aluminum-nickel-manganese composite oxide, and lithium aluminum-nickel-cobalt composite oxide. These positive electrode active materials may be used either alone or in combination with other positive electrode active materials.

When a positive electrode made of lithium cobalt oxide is used with a higher end-of-charge potential, the thermal stability becomes poor although the capacity increases. In view of this, the thermal stability can be enhanced by adding Al to the lithium cobalt oxide. It is preferable that the amount of Al to be added be within the range of from 0.01 mole % to 3.0 mole % with respect to the total amount of the metal elements other than lithium in the lithium cobalt oxide.

The crystal structure of lithium cobalt oxide becomes more instable as the state of charge becomes higher. For this reason, it is preferable that, when using lithium cobalt oxide, Zr and Mg are added to the lithium cobalt oxide. Adding Zr and Mg to lithium cobalt oxide makes it possible to obtain stable charge-discharge cycle performance. It is preferable that the amount of Zr to be added be within the range of from 0.01 mole % to 3.0 mole % with respect to the total amount of the metal elements other than lithium in the lithium cobalt oxide. It is also preferable that the amount of Mg to be added be within the range of from 0.01 mole % to 3.0 mole % with respect to the total amount of the metal elements other than lithium in the lithium cobalt oxide. In addition, it is preferable that Zr be adhered to the surface of the lithium cobalt oxide in particulate form, as disclosed in Patent Document 6.

### [Preparation of Inorganic Particle Layer]

A water-system slurry for forming an inorganic particle layer was prepared using the following materials: water as a solvent, TiO₂ (CR-EL) on which no surface-treatment layer was provided as inorganic particles, sodium polyacrylate (degree of polymerization: 22000-66000, 1% viscosity: 0.89 Pa·s (B-type viscometer, 60 rpm)) as a dispersion stabilizer, and SBR (styrene-butadiene rubber) as a water-system binder. The concentration of the solid content of the inorganic particles was 30 mass %. The amount of the dispersion stabilizer was 1.00 parts by mass per 100 parts by mass of the inorganic particles. The amount of the water-system binder was set at 3 parts by mass per 100 parts by mass of the total of the inorganic particles and the dispersion stabilizer.

The water-system slurry thus prepared was coated on both sides of the positive electrode by gravure coating, and water, serving as the solvent, was removed by drying. Thus, inorganic particle layers were formed on both sides of the positive electrode. The thickness of the inorganic particle layer on one side was set at 2 μm, so that the total thickness of the inorganic particle layers on both sides was 4 μm. If the thickness of the inorganic particle layer on one side is less than 0.5 μm, the advantageous effects obtained by forming the inorganic particle layer may be insufficient. If the thickness of the inorganic particle layers on both sides is greater than 4 μm, the rate performance of the battery may degrade, resulting in a lower energy density.

Examples of the substances usable as the inorganic particles for forming the inorganic particle layer include rutile-type titanium oxide (rutile-type titania), aluminum oxide (alumina), zirconium oxide (zirconia), and magnesium oxide (magnesia). Anatase-type titania, having an anatase structure, is capable of intercalating and deintercalating lithium ions, so it absorbs lithium and exhibits electron conductivity depending on the environmental atmosphere and potential. As a consequence, it may cause problems such as lower capacity and short circuiting. On the other hand, the rutile-type titania does not intercalate or deintercalate lithium, so it is free from the problems associated with the titania having an anatase structure. Taking the stability in the battery (i.e., the reactivity with lithium) and costs into consideration, it is particularly preferable that aluminum oxide or rutile-type titania be used as the inorganic particles.

Although the material for the water-system binder is not particularly limited, it is preferable that the material can satisfy the characteristics including the following comprehensively: (1) the material should ensure sufficient dispersion capability (prevent re-aggregation) of the inorganic particles, (2) the material should ensure sufficient adhesion capability such that it can withstand the manufacturing process of the battery, (3) the material should fill gaps between the inorganic particles resulting from the swelling after absorbing the non-aqueous electrolyte can be filled, and (4) the material should be less dissolvable in the non-aqueous electrolyte than in water. In order to obtain sufficient battery performance, it is preferable to achieve these effects with a small amount of water-system binder. Therefore, it is preferable that the amount of the water-system binder be 30 parts by mass or less, more preferably 10 parts by mass or less, and still more preferably 5 parts by mass or less, per 100 parts by mass of the total of the inorganic particles and the dispersion stabilizer. The lower limit value of the amount of the water-system binder in the inorganic particle layer is generally 0.1 parts by mass or greater. Preferable examples of the material for the water-system binder include polytetrafluoroethylene (PTFE), polyacrylonitrile (PAN), styrene-butadiene rubber (SBR), modified substances thereof, derivatives thereof, copolymers containing acrylonitrile units, and polyacrylic acid derivatives. A copolymer containing acrylonitrile units is preferable especially when the above-listed characteristics (1) to (3) are considered important with a small amount of the water-system binder added. The water-system binder may be used in the form of, for example, emulsion resin or water-soluble resin.

Examples of the method for forming an inorganic particle layer on the positive electrode surface include die coating, gravure coating, dip coating, curtain coating, and spray coating. When degradation of the bonding strength due to diffusion of the solvent and the water-system binder into the electrode is taken into consideration, a method that can coat the water-system slurry quickly with a short drying time is desirable, so die coating and gravure coating are preferable. A preferable concentration of the solid content in the water-system slurry may vary greatly depending on the method of coating. A low concentration of the solid content, for example 3 to 30 parts by mass, is preferable for dip coating, curtain coating, and spray coating, because, with these methods, the thickness of coating is difficult to control mechanically. On the other hand, die coating and gravure coating may accept a higher concentration of the solid content, and for example, about 5 to about 70 parts by mass is preferable.

### Preparation of Negative Electrode

A negative electrode slurry was prepared by mixing a carbon material (graphite) as a negative electrode active material, CMC (carboxymethylcellulose sodium), and SBR (styrene-butadiene rubber) at a weight ratio of 98:1:1. The resultant negative electrode slurry was applied onto both sides of a copper foil, and the resultant material was dried and calendered. Thus, a negative electrode was prepared. The filling density of the negative electrode was set at 1.60 g/cm³.

The negative electrode active material is not limited to graphite. Another example of the usable carbon material is coke. In addition to carbon materials, examples of the material usable as a negative electrode active material include metal oxides, metals that can absorb lithium by alloying with lithium, and metallic lithium.

### [Preparation of Non-aqueous Electrolyte]

A non-aqueous electrolyte was prepared in the following manner. LiPF₆ as a solute was dissolved at a concentration of 1 mole/liter into a mixed solvent of 3:7 volume ratio of ethylene carbonate (EC) and diethyl carbonate (DEC).

The solvent of the non-aqueous electrolyte used in the present invention may be any solvent that has conventionally been used as a solvent for a non-aqueous electrolyte of lithium secondary batteries. Particularly preferable is a mixed solvent of a cyclic carbonate and a chain carbonate. It is preferable that the mixture ratio of the cyclic carbonate and the chain carbonate (cyclic carbonate: chain carbonate) be within the range of from 1:9 to 5:5.

Examples of the cyclic carbonate include ethylene carbonate, propylene carbonate, butylene carbonate, and vinylene carbonate. Examples of the chain carbonate include dimethyl carbonate, methyl ethyl carbonate, and diethyl carbonate. It is also possible to use a mixed solvent of a cyclic carbonate and an ether-system solvent such as 1,2-dimethoxyethane or 1,2-diethoxyethane.

Examples of the usable solute in the non-aqueous electrolyte include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and mixtures thereof. Preferable examples include LiXF_{y} (wherein X is P, As, Sb, B, Bi, Al, Ga, or In, and y is 6 when X is P, As, or Sb or y is 4 when X is B, Bi, Al, Ga, or In), lithium perfluoroalkylsulfonic imide LiN(CₘF₂ₘ₊₁SO₂)(CₙF₂ₙ₊₁SO₂) (wherein m and n denote, independently of one another, an integer of from 1 to 4), lithium perfluoroalkylsulfonic methide LiC(CₚF₂ₚ₊₁SO₂)(C_{q}F_{2q+1}SO₂)(CᵣF₂₊₁SO₂) (wherein p, q, and r denote, independently of one another, an integer of from 1 to 4), and mixtures thereof.

Examples of the usable non-aqueous electrolyte include gelled polymer electrolytes in which an electrolyte solution is impregnated in a polymer electrolyte such as polyethylene oxide or polyacrylonitrile, and inorganic solid electrolytes such as LiI and Li₃N.

There is no limitation to the electrolyte of the non-aqueous electrolyte secondary battery, and any type of electrolyte may be used as long as the lithium compound used as the solute for providing ionic conductivity and the solvent used for dissolving and retaining the solute are not decomposed at a voltage during charge and discharge or at a voltage during the storage of the battery.

### [Construction of Battery]

Lead terminals were attached to the positive electrode and the negative electrode prepared in the above-described manner, and they were spirally wound with separators interposed therebetween. These were pressed into a flat shape to prepare an electrode assembly. The electrode assembly was inserted into an aluminum laminate serving as a battery case. Thereafter, the non-aqueous electrolyte was filled therein, and the battery case was sealed. Thus, a lithium secondary battery was prepared. This lithium secondary battery is referred to as a battery T1.

The design capacity of the battery T1 was set at 850 mAh. The battery was designed so that the end-of-charge potential of the positive electrode became 4.50 V (vs. Li/Li⁺), and it was also designed so that the capacity ratio of the positive electrode and the negative electrode (the initial charge capacity of the negative electrode/the initial charge capacity of the positive electrode) became 1.08 at the above-mentioned potential. The separator used was a microporous polyethylene film having an average pore size of 0.1 μm, a film thickness of 16 μm, and a porosity of 47%.

It is preferable that the ratio of the charge capacity of the negative electrode to the charge capacity of the positive electrode (negative electrode charge capacity/positive electrode charge capacity) be within the range of from 1.0 to 1.1.

### Example 2

A battery was prepared in the same manner as described in Example 1, except that the sodium polyacrylate was added in an amount of 0.50 parts by mass per 100 parts by mass of the inorganic particles. This battery is referred to as a battery T2.

### Example 3

A battery was prepared in the same manner as described in Example 1, except that the sodium polyacrylate used as the dispersion stabilizer was added in an amount of 0.10 parts by mass per 100 parts by mass of the inorganic particles. This battery is referred to as a battery T3.

### Example 4

A battery was prepared in the same manner as described in Example 1, except that sodium polyacrylate (degree of polymerization: 6000-10000) was used as the dispersion stabilizer, and that this sodium polyacrylate was added in an amount of 0.10 parts by mass per 100 parts by mass of the inorganic particles. This battery is referred to as a battery T4.

### Example 5

A battery was prepared in the same manner as described in Example 1, except that the sodium polyacrylate was added in an amount of 0.01 parts by mass per 100 parts by mass of the inorganic particles. This battery is referred to as a battery T5.

### Example 6

A battery was prepared in the same manner as described in Example 1, except that polyacrylic acid (degree of polymerization: 25000) was used as the dispersion stabilizer, and that this polyacrylic acid was added in an amount of 0.10 parts by mass per 100 parts by mass of the inorganic particles. This battery is referred to as a battery T6.

### Comparative Example 1

A battery was prepared in the same manner as described in Example 1, except that no inorganic particle layer was provided on the positive electrode surface. This battery is referred to as a battery R1.

### Comparative Example 2

A water-system slurry was prepared in the same conditions as described in Example 1 except that no dispersion stabilizer was used. The inorganic particles settled in the resultant water-system slurry, so the inorganic particle layer was unable to be formed on the positive electrode surface in a desirable manner with the resultant water-system slurry. For this reason, the battery performance was not evaluated for a battery R2, which employed a positive electrode prepared according to Comparative Example 2

### Comparative Example 3

A water-system slurry was prepared under the same conditions as described in Example 1, except that CMC (item number 1380, made by Daicel Chemical Industries, Ltd., 1% viscosity: 1.16 Pa·s (B-type viscometer, 60 rpm)) was used as the dispersion stabilizer, and that the CMC (1380) was added in an amount of 0.1 parts by mass per 100 parts by mass of the inorganic particles.

The water-system slurry prepared according to Comparative Example 3 was unable to form the inorganic particle layer in a desirable condition, since the inorganic particles settled therein. For this reason, the battery performance was not evaluated for a battery R3 prepared according to Comparative Example 3.

### Comparative Example 4

A water-system slurry was prepared under the same conditions as described in Example 1, except that CMC (item number BSH-12, made by Dai-ichi Kogyo Seiyaku Corp., 1% viscosity: 5.86 Pa·s (B-type viscometer, 60 rpm)) was used as the dispersion stabilizer, and that this CMC (BSH-12) was added in an amount of 0.1 parts by mass per 100 parts by mass of the inorganic particles.

The water-system slurry prepared according to Comparative Example 4 was unable to form the inorganic particle layer in a desirable condition, since the inorganic particles settled therein. For this reason, the battery performance was not evaluated for a battery R4 prepared according to Comparative Example 4.

### (1) Evaluation of Storage Performance of the Batteries

The batteries prepared in the above-described manners were subjected to a charge-discharge cycle test (charge→rest→discharge) one time, then charged again, and then set aside at 60° C. for 20 days. Thereafter, each of the batteries was cooled to room temperature, and then discharged at a rate of 1 It, to calculate the retention ratio for each battery using the following equation. The retention ratio at 60° C. for each battery is shown as storage performance in Table 2.

Retention ratio(%)={(Discharge capacity obtained at the first-time discharge after the storage test)/(Discharge capacity obtained before the storage test)}×100

[Charge Conditions]

Each of the batteries was charged at a constant current of 1 It (850 mA) until the potential of the positive electrode reached an end-of-charge potential of 4.50 V (vs. Li/Li+) and further charged at a constant voltage to a current of 0.05 It (42.5 mA).

[Discharge Conditions]

Each of the batteries was discharged at a constant current of 1 It (850 mA) until the potential of the positive electrode reached 3.10 V (vs. Li/Li⁺).

[Rest]

Each of the batteries was rested for 10 minutes and thereafter discharged.

### (2) Evaluation of Sedimentation

100 g of each sample of the water-system slurries was weighed in a transparent container, and the height of the deposited substance was measured after one hour and one day. Thereafter, the sedimentation of each sample of the inorganic particles was determined as follows, from the relationship between the height of the deposited substance and the height of each sample of the water-system slurries before starting the test.

Good: Height of the deposited substance÷ Height of the water-system slurry before starting the test×100≧80%

Fair: 80%>Height of the deposited substance÷ Height of the water-system slurry before starting the test×100≧50%

Poor: 50%>Height of the deposited substance÷ Height of the water-system slurry before starting the test×100 (≧0%)

For each sample of the inorganic particles, the sedimentation obtained one hour after the preparation of the water-system slurry (denoted as “Sedimentation after 1 hour”) and the sedimentation obtained one day after the preparation of the water-system slurry (denoted as “Sedimentation after 1 day”) are shown in Table 2.

### (3) Evaluation of Discharge Rate Performance of the Batteries

Each of the batteries prepared in the above-described manners was subjected to a charge-discharge cycle test one time under the same conditions as described in the evaluation of storage performance, and then charged again under the same conditions as described in the evaluation of storage performance. Thereafter, each battery was discharged at a constant current of 3 It (2550 mA) to 3.0 V. For each battery, the discharge rate ratio was calculated according to the following equation. The results are shown in Table 2.

Discharge rate ratio(%)={Discharge capacity obtained by discharge at 3It)/(Discharge capacity obtained by discharge at 1It)}×100

TABLE 2

| | | | Amount | | | | Retention ratio |
|---|---|---|---|---|---|---|---|
| | Dispersion | Degree of | added | Sedimentation | Sedimentation | Discharge | (Storage |
| Battery | stabilizer | polymerization | (%) | after 1 hour | after 1 day | rate ratio | performance) |
| T1 | Sodium | 22000-66000 | 1.00 | Good | Good | 38.9% | 52.5% |
| | polyacrylate | | | | | | |
| T2 | Sodium | 22000-66000 | 0.50 | Good | Good | 51.0% | 69.2% |
| | polyacrylate | | | | | | |
| T3 | Sodium | 22000-66000 | 0.10 | Good | Good | 52.2% | 72.1% |
| | polyacrylate | | | | | | |
| T4 | Sodium | 6000-10000 | 0.10 | Fair | Poor | 49.1% | 58.7% |
| | polyacrylate | | | | | | |
| T5 | Sodium | 22000-66000 | 0.01 | Fair | Poor | 56.4% | 68.5% |
| | polyacrylate | | | | | | |
| T6 | Polyacrylic | 25000 | 0.10 | Fair | Poor | 48.5% | 51.2% |
| | acid | | | | | | |
| R1 | — | — | — | — | — | 42.6% | 35.2% |

| | | | | | | |
|---|---|---|---|---|---|---|
| R2 | Not added | — | — | Poor | Poor | Unable to evaluate |
| R3 | CMC | — | 0.10 | Poor | Poor | Unable to evaluate |
| | (1380) | | | | | |
| R4 | CMC | — | 0.10 | Poor | Poor | Unable to evaluate |
| | (BSH-12) | | | | | |

The battery T1, which was provided with the inorganic particle layer, exhibited a significant improvement in storage performance over the battery R1, which was not provided with the inorganic particle layer. The batteries T2 to T6, each of which was provided with the inorganic particle layer, exhibited improvements in discharge rate ratio, thus improvements in discharge rate performance, over the battery R1, which was not provided with the inorganic particle layer. The batteries T2 to T6 also showed improvements in storage performance. This demonstrates that storage performance can be improved by forming the inorganic particle layer. In addition, it is appreciated from the relationship between the battery T1 and the batteries T2 to T6 that both the discharge rate performance and storage performance at high temperatures can be improved by setting the concentration of the dispersion stabilizer within the inorganic particle layer to 0.01% to 0.5% with respect to the amount of the inorganic particles.

The water-system slurries of the batteries T1 to T6, which used a polyacrylic acid or a polyacrylate as the dispersion stabilizer, were able to inhibit sedimentation of the inorganic particles, so the water-system slurries were prepared with good dispersion capability of the inorganic particles. On the other hand, the water-system slurry that was prepared without using a dispersion stabilizer (Comparative Example 2) was unable to form an inorganic particle layer on a positive electrode surface since the inorganic particles settled in the water-system slurry. Therefore, it is demonstrated that an inorganic particle layer with a desirable condition can be formed on a positive electrode surface by adding a dispersion stabilizer to the water-system slurry.

In addition, the water-system slurries prepared using CMC as the dispersion stabilizer (Comparative Examples 5 and 6) were also unable to form an inorganic particle layer on a positive electrode surface since the inorganic particles settled therein. This indicates that stability of the water-system slurry cannot be enhanced even when a substance with a high viscosity is used as the dispersion stabilizer. By employing a polyacrylic acid or a polyacrylate as the dispersion stabilizer, the dispersion stabilizer acts on the inorganic particles, ensuring the dispersion stability of the water-system slurry. Thus, the inorganic particles are dispersed in the inorganic particle layers of the batteries T1 to T6 in good condition, so the inorganic particle layers can exhibit the filtering function sufficiently. Moreover, they are able to improve storage performance at high temperatures.

It should be noted that even the water-system slurries that were determined as “fair” in the evaluation of the sedimentation after 1 hour can be coated on the positive electrode before the sedimentation occurs, so it is possible to form the inorganic particle layer and fabricate batteries even with such water-system slurries. On the other hand, the water-system slurries of the batteries that were determined as “good” for both “sedimentation after 1 hour” and “sedimentation after 1 day” can be evaluated as showing little change in sedimentation over time. Therefore, by using such a water-system slurry for mass production, it is possible to inhibit variations in quality between the inorganic particle layers produced.

When comparing the battery T3 and the battery T4, the one in which the molecular weight of the sodium polyacrylate used as the dispersion stabilizer is 22000 or greater was able to prepare a water-system slurry in which the inorganic particles were dispersed desirably, and also it resulted in both better discharge rate performance and better storage performance.

When comparing the batteries T3, T4, and T6 with each other, which had the same amount of the dispersion stabilizer with respect to the amount of the inorganic particles, the battery T6 showed a lower discharge rate ratio and a lower retention ratio than the other batteries. This is believed to be because, when a polyacrylic acid is used as the dispersion stabilizer, the water-system slurry tends to be acidic and impair the dispersion stability. The slurry may be gelled depending on the amount of the polyacrylic acid added, and the coating may become difficult. Therefore, it is more preferable that the dispersion stabilizer be a polyacrylate.

It is desirable that, when a polyacrylic acid is used as the dispersion stabilizer, the polyacrylic acid be neutralized with cations. Examples of the cations include, but are not particularly limited to, inorganic cations including alkali metals such as sodium and potassium and alkaline-earth metals such as calcium and magnesium, and organic cations such as quaternary amines. However, sodium cations, which do not adversely affect the battery performance, are preferable.

### 3. Preparation of Battery (2)

### Example 7

Aluminum oxide (AKP 3000) having no surface-treatment layer was used for the inorganic particles. Sodium polyacrylate used as the dispersion stabilizer was added in an amount of 0.1 parts by mass per 100 parts by mass of the inorganic particles. A battery was prepared in the same manner as described in Example 1 except for the just-described conditions. This battery is referred to as a battery T7. The sedimentation of the inorganic particles, the discharge rate ratio, and the retention ratio (storage performance) of the battery were evaluated for the battery T7 also in the same manner as used for the battery T1. The results are shown in Table 3.

### Comparative Example 5

A water-system slurry was prepared using aluminum oxide (AKP 3000) for the inorganic particles and without using a dispersion stabilizer. This water-system slurry was unable to form the inorganic particle layer in a desirable condition since the inorganic particles settled therein. For this reason, the battery performance was not evaluated for a battery R5, which employed a positive electrode prepared according to Comparative Example 5.

TABLE 3

| | | | Amount | | | | Retention ratio |
|---|---|---|---|---|---|---|---|
| | Dispersion | Degree of | added | Sedimentation | Sedimentation | Discharge | (Storage |
| Battery | stabilizer | polymerization | (%) | after 1 hour | after 1 day | rate ratio | performance) |
| T7 | Sodium | 22000-66000 | 0.10 | Good | Good | 55.3% | 71.9% |
| | polyacrylate | | | | | | |

| | | | | | | |
|---|---|---|---|---|---|---|
| R5 | Not added | — | — | Poor | Poor | Unable to evaluate |

The water-system slurry containing a dispersion stabilizer was unable to form the inorganic particle layer, while the water-system slurry containing a dispersion stabilizer was able to form the inorganic particle layer. The battery T7 was able to obtain similar results to the batteries T1 to T6 for the sedimentation of the inorganic particles, the discharge rate performance, and the storage performance. This indicates that, even when aluminum oxide (AKP3000) is used as the inorganic particles, the use of the dispersion stabilizer comprising a polyacrylic acid or a polyacrylate inhibits sedimentation of the inorganic particles and makes it possible to prepare a water-system slurry in which the inorganic particles are dispersed desirably. With such a water-system slurry, an inorganic particle layer with a desirable dispersion condition can be formed, the filtering function of the inorganic particle layer can be exhibited sufficiently, and the storage performance at high temperatures can be improved.

### 4. Preparation of Battery (3)

### Example 8

Titanium oxide (KR380) in which a surface-treatment layer was provided was used for the inorganic particles. Sodium polyacrylate used as the dispersion stabilizer was added in an amount of 0.1 parts by mass per 100 parts by mass of the inorganic particles. A battery was prepared in the same manner as described in Example 1 except for the just-described conditions. This battery is referred to as a battery T8.

### Comparative Example 6

A water-system slurry was prepared using titanium oxide (KR380) for the inorganic particles and without using a dispersion stabilizer. This water-system slurry was coated on the positive electrode surface to form an inorganic particle layer in the same manner as described in Example 1. Using the positive electrode on which the inorganic particle layer was provided, a battery was prepared in the same manner as described in Example 1. This battery is referred to as a battery R6.

The sedimentation of the inorganic particles and the discharge rate ratio and retention ratio (storage performance) of the battery were evaluated for the batteries T8 and R6 in the same manner as used for the battery T1. The results are shown in Table 4.

TABLE 4

| | | | | | | | Retention |
|---|---|---|---|---|---|---|---|
| | | | Amount | Sedimentation | Sedimentation | | ratio |
| | Dispersion | Degree of | added | on after 1 | on after 1 | Discharge | (Storage |
| Battery | stabilizer | polymerization | (%) | hour | day | rate ratio | performance) |
| T8 | Sodium | 22000-66000 | 0.10 | Good | Good | 55.7% | 71.3% |
| | polyacrylate | | | | | | |
| R6 | Not added | — | — | Good | Poor | 50.7% | 64.4% |

The battery T8 exhibited improvements in the sedimentation of the inorganic particles 1 day after the preparation, the discharge rate performance, and the storage performance over the battery R6. This indicates that, even when titanium oxide having a surface-treatment layer is used as the inorganic particles, the use of the dispersion stabilizer comprising a polyacrylic acid or a polyacrylate inhibits sedimentation of the inorganic particles and makes it possible to prepare a water-system slurry in which the inorganic particles are dispersed desirably. In other words, with the inorganic particles on which a surface-treatment layer is provided, the dispersion stability of the inorganic particles in the water-system slurry can be maintained for a long time. Thus, even with a water-system slurry that uses titanium oxide having a surface-treatment layer as the inorganic particles, an inorganic particle layer in which the inorganic particles is desirably dispersed can be formed, so the filtering function of the inorganic particle layer can be exhibited sufficiently and the storage performance at high temperatures can be improved.

### 5. Additional Analysis

For the batteries R2 and R5, the water-system slurries were prepared without adding a dispersion stabilizer. The batteries R2 and R5, in which the water-system slurry was prepared using the inorganic particles having no surface-treatment layer, were not able to form the inorganic particle layer since the inorganic particles settled. This is believed to be because the inorganic particles having no surface-treatment layer tend to cause aggregation, degrading the dispersion capability. Accordingly, an additional advantageous effect of the dispersion stabilizer may be that it will broaden the range of choices for materials of the inorganic particles because the inorganic particles that have no surface-treatment layer can also be employed as the inorganic particles of the water-system slurry.

When the inorganic particles provided with a surface-treatment layer are used for the inorganic particle layer, micro-short circuiting may occur between the positive electrode and the negative electrode during charge-discharge cycles. Such micro-short circuiting is believed to be due to the impurities containing Fe, which are contained in the inorganic particles. For this reason, it is preferable to use inorganic particles having no surface-treatment layer as the inorganic particles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

What is claimed is:

1. A non-aqueous electrolyte battery comprising: a positive electrode containing a positive electrode active material, a negative electrode containing a negative electrode active material, a non-aqueous electrolyte, a separator provided between the positive electrode and the negative electrode, and an inorganic particle layer provided on a surface of the positive electrode, wherein the inorganic particle layer contains inorganic particles, a dispersion stabilizer comprising at least one of a polyacrylic acid and a polyacrylate, and a water-system binder that is different from the dispersion stabilizer.

2. The non-aqueous electrolyte secondary battery according to claim 1, wherein the inorganic particles have no surface-treatment layer.

3. The non-aqueous electrolyte secondary battery according to claim 1, wherein the polyacrylic acid and/or the polyacrylate has/have a degree of polymerization of from 22000 to 66000.

4. The non-aqueous electrolyte secondary battery according to claim 1, wherein the concentration of the dispersion stabilizer is within a range of from 0.01 parts by mass to 0.5 parts by mass, per 100 parts by mass of the inorganic particles.

5. The non-aqueous electrolyte secondary battery according to claim 1, wherein the inorganic particles comprise at least one of rutile-type titania and alumina.

6. The non-aqueous electrolyte secondary battery according to claim 1, wherein the positive electrode has a filling density of 3.40 g/cm³ or greater.

7. The non-aqueous electrolyte battery according to claim 1, wherein the non-aqueous electrolyte secondary battery is charged until the end-of-charge potential of the positive electrode reaches higher than 4.30 V (vs. Li/Li⁺).

8. A method of manufacturing a non-aqueous electrolyte secondary battery according claim 1, comprising the steps of:
preparing a water-system slurry containing the inorganic particles, the dispersion stabilizer, and the water-system binder;
coating the water-system slurry onto a surface of the positive electrode to form the inorganic particle layer; and
manufacturing a non-aqueous electrolyte secondary battery by using the positive electrode on which the inorganic particle layer is formed on the surface, the negative electrode, the non-aqueous electrolyte, and the separator.

9. A method of manufacturing a non-aqueous electrolyte secondary battery according to claim 2, comprising the steps of:
preparing a water-system slurry containing the inorganic particles, the dispersion stabilizer, and the water-system binder;
coating the water-system slurry onto a surface of the positive electrode to form the inorganic particle layer; and
manufacturing a non-aqueous electrolyte secondary battery by using the positive electrode on which the inorganic particle layer is formed on the surface, the negative electrode, the non-aqueous electrolyte, and the separator.

10. A method of manufacturing a non-aqueous electrolyte secondary battery according to claim 3, comprising the steps of:
preparing a water-system slurry containing the inorganic particles, the dispersion stabilizer, and the water-system binder;
coating the water-system slurry onto a surface of the positive electrode to form the inorganic particle layer; and
manufacturing a non-aqueous electrolyte secondary battery by using the positive electrode on which the inorganic particle layer is formed on the surface, the negative electrode, the non-aqueous electrolyte, and the separator.

11. A method of manufacturing a non-aqueous electrolyte secondary battery according claim 4, comprising the steps of
preparing a water-system slurry containing the inorganic particles, the dispersion stabilizer, and the water-system binder;
coating the water-system slurry onto a surface of the positive electrode to form the inorganic particle layer; and
manufacturing a non-aqueous electrolyte secondary battery by using the positive electrode on which the inorganic particle layer is formed on the surface, the negative electrode, the non-aqueous electrolyte, and the separator.

12. A method of manufacturing a non-aqueous electrolyte secondary battery according claim 5, comprising the steps of
preparing a water-system slurry containing the inorganic particles, the dispersion stabilizer, and the water-system binder;
coating the water-system slurry onto a surface of the positive electrode to form the inorganic particle layer; and
manufacturing a non-aqueous electrolyte secondary battery by using the positive electrode on which the inorganic particle layer is formed on the surface, the negative electrode, the non-aqueous electrolyte, and the separator.

13. A method of manufacturing a non-aqueous electrolyte secondary battery according claim 6, comprising the steps of:
preparing a water-system slurry containing the inorganic particles, the dispersion stabilizer, and the water-system binder;
coating the water-system slurry onto a surface of the positive electrode to form the inorganic particle layer; and
manufacturing a non-aqueous electrolyte secondary battery by using the positive electrode on which the inorganic particle layer is formed on the surface, the negative electrode, the non-aqueous electrolyte, and the separator.

14. A method of manufacturing a non-aqueous electrolyte secondary battery according claim 7, comprising the steps of:
preparing a water-system slurry containing the inorganic particles, the dispersion stabilizer, and the water-system binder;
coating the water-system slurry onto a surface of the positive electrode to form the inorganic particle layer; and
manufacturing a non-aqueous electrolyte secondary battery by using the positive electrode on which the inorganic particle layer is formed on the surface, the negative electrode, the non-aqueous electrolyte, and the separator.
